(19) United States
(12) Patent Application Publication
(10) Pub. No.: US 2011/0093783 A1
(43) Pub. Date: Apr. 21, 2011

(54) METHOD AND SYSTEM FOR LINKING MEDIA COMPONENTS

(76) Inventor: Charles PARRA, New York, NY (US)

(21) Appl. No.: 12/711,848

(22) Filed: Feb. 24, 2010

Related U.S. Application Data
(60) Provisional application No. 61/252,499, filed on Oct. 16, 2009.

(51) Int. Cl. G06F 15/16; G06F 11/20; G06F 17/30; H04N 9/80; G06F 3/00

(52) U.S. Cl. 715/719; 709/203; 707/758; 714/E11.071; 707/E17.014; 386/249

(57) ABSTRACT

A system and method for linking media components may include a processor that executes a handshake protocol according to which a video component is rendered conditional upon receipt of notification of rendering of an associated media component. The system and method may additionally perform a keyword comparison algorithm to determine a relevancy between the video and other associated media component.

### FIELD OF THE INVENTION

This application claims the benefit, under 35 U.S.C. §119(e), of U.S. Provisional Patent Application No. 61/252,499, filed Oct. 16, 2009, the entire contents of which is hereby incorporated by reference in its entirety.

### FIELD OF THE INVENTION

The present invention relates to a system and method for linking media components, e.g., a video advertisement with a companion banner advertisement.

### BACKGROUND

Advertisements are used to persuade a targeted audience of a certain notion and/or to do a certain act, and/or to inform the targeted audience of certain information. Advertisements may take on a variety of forms, and the selected form may depend on the purpose of the advertisement. Further, an advertisement can be presented in a combination of forms, for example, where the combination serves a number of purposes.

For example, a drug company may present in a webpage a streaming video advertisement for one of its drugs, which can depict a lifestyle improvement of one who uses the drug. The purpose of the streaming video may be for persuading the targeted audience of the benefits and effectiveness of, and to purchase, the drug. On the other hand, important additional information about the drug may be included in an accompanying banner advertisement, the purpose of which may be strictly informative and/or for regulatory compliance, e.g., compliance with a U.S. Food and Drug Administration (FDA) regulation to display warnings regarding an advertised drug. Similarly, content other than advertisements may be packaged in a combination of media types including video and banner.

While the combinatory media, e.g., advertisements may be provided to the same viewer device, the avenues and/or methods by which they are provided often differ, which can result in their inadvertent disassociation. For example, it can occur that a video advertisement is played in a webpage without its accompanying banner advertisement in violation of a regulation, e.g., where an error occurs in the medium via which the banner advertisement is provided. Disassociation may also occur, for example, where the video advertisement is provided in a webpage that does not provide a placeholder for rendering of banner advertisements, or where an error in an advertisement data package results in the omission of the banner advertisement from the advertisement data package.

### SUMMARY

Embodiments of the present invention provide a system and method that ensures the output of a first media, e.g., advertisement, component only where an accompanying media, e.g., advertisement, component with which the first media component is associated is also output. The system and method may be implemented using software module components such as those described in U.S. patent application Ser. Nos. 11/331,684, 12/420,137, and 12/420,139, all of the contents of each of which are incorporated herein by reference in their entirety.

The various methods described herein may be practiced, each alone, or in various combinations.

An example embodiment of the present invention is directed to one or more processors, which may be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination. The one or more processors may be embodied in a server or user terminal or combination thereof. The user terminal may be embodied, for example, as a desktop, laptop, hand-held device, Personal Digital Assistant (PDA), television set-top Internet appliance, mobile telephone, smart phone, etc., or as a combination of one or more thereof. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present invention is directed to a hardware computer-readable medium, e.g., as described above, having stored thereon instructions executable by a processor to perform the methods described herein.

An example embodiment of the present invention is directed to a method, e.g., of a hardware component or machine, of transmitting instructions executable by a processor to perform the methods described herein.

### BRIEF DESCRIPTION OF THE DRAWINGS

FIG. 1 is a flowchart that illustrates an example method of synchronizing the rendering of related media components, according to an example embodiment of the present invention.

FIG. 2 is a flowchart that illustrates an example method of checking a relevancy of associated media components to each other, according to an example embodiment of the present invention.

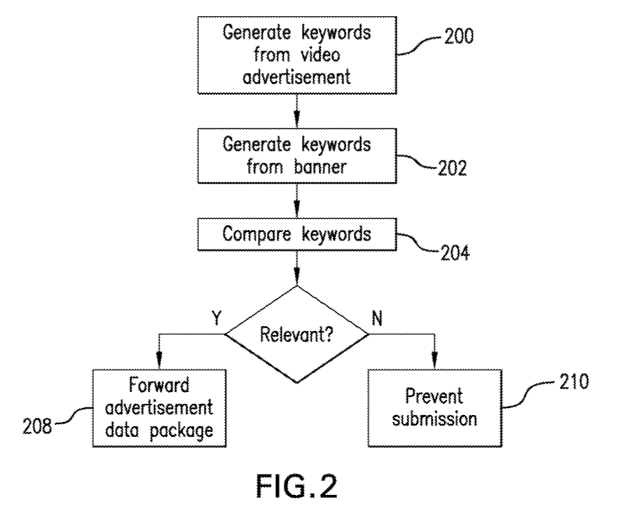

FIG. 3 is a diagram that illustrates components of a system, according to an example embodiment of the present invention.

### DETAILED DESCRIPTION

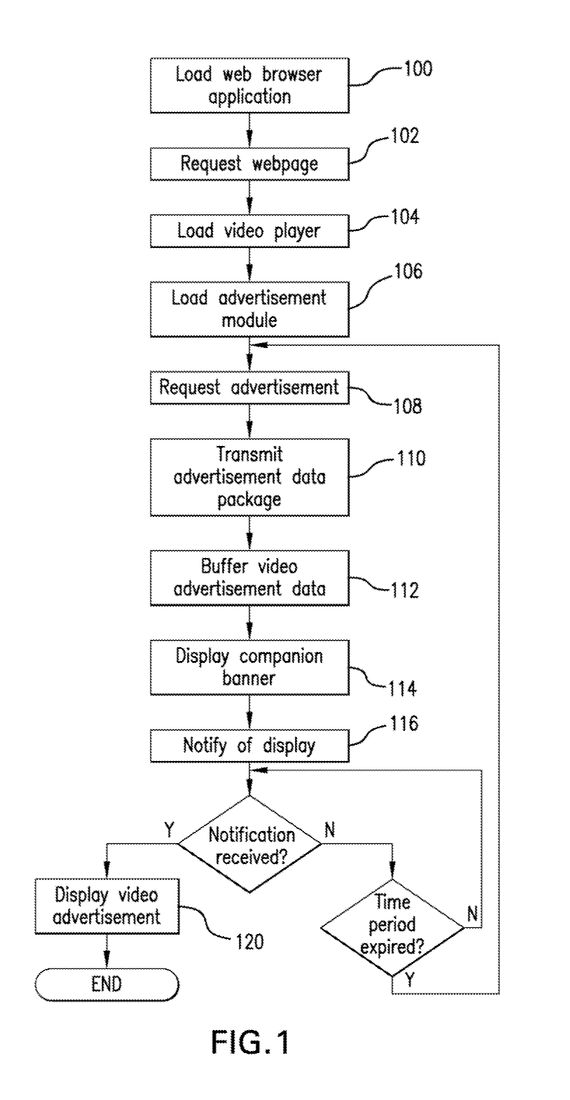

FIG. 1 is a flowchart that illustrates steps of a method for ensuring that a rendered video advertisement associated with a companion banner is played conditionally on the rendering of its companion banner. A user may input instructions for loading a web browser application at a user terminal. At step 100, a processor of the user terminal may responsively load the web browser application from memory. Via user-interaction with the web browser application, the system and method may navigate, via the web browser application, webpages of one or more websites. During the navigation, the system and method may, at step 102, transmit via the web browser application and to a content server a request for a webpage. At step 104, the content server may return webpage data, e.g., Hyper Text Markup Language (HTML) data, to the user terminal. The webpage data may include data for the web browser application to render components of the requested webpage.

The returned webpage may include various types of components. A non-exclusive list of such components includes graphics, text, links to other webpages, and placeholders for insertion therein of other data to be subsequently obtained by the user terminal. The placeholders may include, for example, a placeholder for subsequently obtained static or applet-driven dynamic content, such as advertisement data and/or a placeholder for subsequently obtained video data, e.g., streaming data, such as a video advertisement.

For the video data, the system and method may, at step 104, load a video player. Where a video advertisement is to be displayed in the placeholder, the video player may, at step 106, load an advertisement module for handling rendering of advertisements. In an example embodiment, the advertisement module may be loaded for handling the obtaining and rendering of static advertisements as well.

At step 108, the advertisement module may transmit to an advertisement server an advertisement request. At step 110, the advertisement server may transmit to the advertisement module execution layer of the user terminal an advertisement data package, e.g., an eXtensible Markup Language (XML) file, for example that includes video advertisement data and companion banner data with which the video advertisement is associated. Handshake code may be embedded in the banner data. (It will be appreciated that in other instances an advertisement may include only a video advertisement or only a static or applet driven advertisement.)

Upon receipt of the data package, at step 112, the advertisement module may responsively begin to buffer the video advertisement data in a memory buffer of the user terminal. The advertisement module may also, at step 114, provide the companion banner data to the web browser application for rendering by the web browser application of the companion banner in the placeholder component of the webpage allocated to display of the companion banner.

Responsive to receipt of the companion banner data, the web browser application may render the companion banner data. The rendering of the companion banner data may include, at step 116, displaying the companion banner in the appropriate placeholder component of the webpage. Responsive to the display of the companion banner, the processor that executes the web browser application may execute the embedded handshake code. The execution of the handshake code causes the web browser application to, at step 118, notify the advertisement module of the display of the companion banner. In an instance where the companion banner is not displayed, the code is not executed and the advertisement module is then not informed of any display of the companion banner.

In an example embodiment, the advertisement data package further includes code for handling by the advertisement module with respect to the rendering of the video advertisement. Alternatively, the advertisement data package includes a flag having a set state and the advertisement module includes code for checking a state of the flag prior to display of the video advertisement. If the display of the video advertisement is to be contingent on the display of the companion banner, then the flag may be set in the advertisement package to a first state. Otherwise, the flag may be set in the advertisement package to a second state. Data transmission time may be reduced according to the latter embodiment in which a flag is used. The code or the setting of the flag to the first state causes the advertisement module to display the buffered video conditionally, only where the advertisement module receives the notification of the rendering of the companion banner.

Accordingly, if a notification of the display of the companion banner is received, the advertisement module may, at step 120, display the video advertisement in the placeholder component of the webpage allocated to video, after which the method for display of the video advertisement may end. While the webpage, including the placeholder component, may be rendered by the web browser application, the advertisement module may handle the display of the video advertisement in the video placeholder component. Subsequent to the display of the video advertisement, if other video content was provided by the content server to the web browser application, the video player may display the other video content in the video placeholder component. Additionally, other video content may be displayed in the video placeholder component prior to the playing of the video advertisement and/or companion banner. In an example embodiment, different video advertisements may be displayed at various points interrupting the playing of video content at those various points, for example, as described in U.S. patent application Ser. No. 11/331,684.

If a notification of the display of the companion banner is not received, the advertisement module may pass control back to the video player to continue or begin display of video content received from the content server, if any, the display of the video advertisement being omitted. Alternatively, as illustrated in FIG. 1, the system and method may proceed back to step 108 to request a new advertisement data package from the same or a different advertisement server. In an example embodiment, these alternatives, i.e., passing control back to the video player or proceeding back to step 108, may be performed after expiration of a predetermined amount of time, by expiration of which the notification is expected in an instance in which the companion banner is displayed. Where no video content is provided by the content server, or where all video content from the content server has already been played, then according to the embodiment in which new advertisements are not requested, after expiration of the predetermined time period, the method may simply end, all renderable components having been rendered. The system may thus enter a waiting state in which media components are not rendered by the web browser, video player, and advertisement modules until further input is received, e.g., from a user for continued navigation of webpages.

According to the embodiment in which the advertisement module proceeds back to step 108 to request new advertisement data, the new request may be made in a manner geared to minimize the chance of recurrence of obtaining in response the same advertisement data package previously received. For example, interactions by the advertisement module with advertisement servers may include use of a failover mechanism, e.g., as described in U.S. patent application Ser. No. 12/420,137, where the failure to receive the notification of display of the companion banner is treated as the failure to obtain advertisement content via a primary link, such that a failover link is used for the repeated performance of step 108. According to this embodiment, in response to the requests made at step 108, the initial advertisement server that receives the request may initially provide a data package that includes a primary link to another downstream advertisement for obtaining the advertisement data package and a failover link back to the initial advertisement server.

In an alternative example embodiment, the server that receives the requests made at step 108 provides the advertisement data package directly to the user terminal. According to this embodiment and in the embodiment in which step 108 is re-performed, for a re-performance of step 108, the advertisement module may insert into the renewed advertisement request a notification of the failure of the rendering of the companion banner. The advertisement server may accordingly refrain from providing another video advertisement requiring a companion banner in response to the renewed advertisement request.

Not all video advertisements are associated with companion banners. Further, not all video advertisements that are associated with companion banners require display of the associated companion banners for display of the video advertisements. For example, not all video advertisements are subject to regulations that require the display of their associated companion banners, and not all video advertisements lack all necessary information required by such regulation. Therefore, advertisement packages, which include video advertisement data and companion banner data, may be provided without the described handshake code and/or flag setting. Where the video advertisement may be displayed even if its companion banner is not, the handshake code or flag bit may be omitted, of the flag may be set to a different state which does not trigger the advertisement module to condition display of the video advertisement on the display of the companion banner. Whether the described code is included or the flag is set to condition display of the video advertisement on the display of the companion banner may be determined by a user. For example, the system and method of the present invention may provide a user interface via which advertisement data packages are created. The user interface may include an option, which, if selected, adds the described handshake code and/or flag setting. The user interface may be provided in a display device of a processing device executing an application for advertisement creation.

While the embodiment described above provides for the advertisement module to play the video advertisement and handle the handshake code with the web browser, in an alternative example embodiment, the video player may play the video advertisement and/or implement the handshake code, where the notification is provided by the web browser to the video player. Similarly, while the embodiment described above refers to the video player and the advertisement module as separate modules, in an alternative example embodiment, the same module may perform the functions described above for both the video player and the advertisement module.

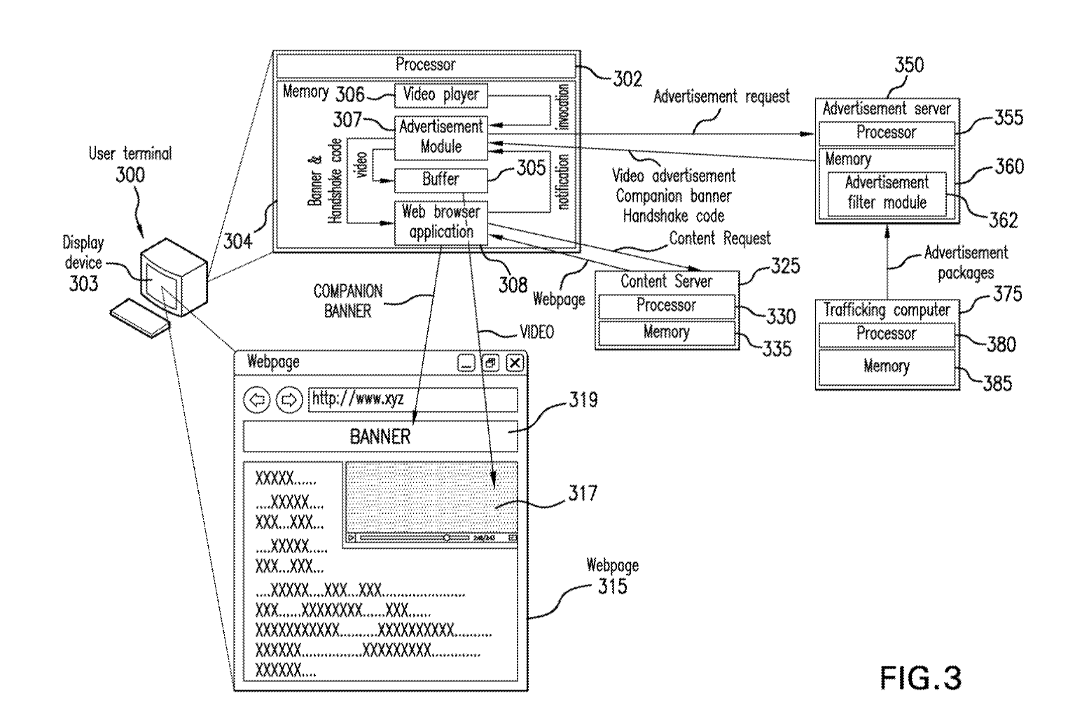

Aside from enduring display of a companion banner for display of an associated video advertisement, in an example embodiment of the present invention, the system and method may perform a method, as illustrated in FIG. 3, to prevent a mismatch between a video advertisement and a companion banner. Such a mismatch may occur, for example, due to human error when creating the advertisement data packages. Generally, a user operates a creation or trafficking computer or application of a computer to define an advertisement package, which may be defined to include a video advertisement and accompanying companion banner. The defined package may be stored in a database, which may be accessed by an advertisement server device or application of a device for provision of the advertisement data package to the advertisement module in response to an advertisement request. The user of the trafficking computer or application may mistakenly associate a video advertisement with the wrong companion banner.

Accordingly, a video-to-banner matching module e.g., running on the trafficking computer or on the advertisement server may, at step 200, generate keywords from a video advertisement, e.g., using a speech-to-text conversion or based on metadata associated with the video advertisement. (Alternatively, the advertisement data package may include keywords associated with the video advertisement, which keywords may be used instead.) At step 202, the video-to-banner matching module generates keywords from the text of the companion banner or based on metadata associated with the banner. (Alternatively, the advertisement data package may include keywords associated with the companion banner, which keywords may be used instead.) At step 204, the video-to-banner matching module may compare the keywords generated for the video advertisement and the keywords generated for the companion banner. Based on the comparison, the video-to-banner matching module may determine, at step 206, whether the companion banner is relevant to the video advertisement. If the video-to-banner matching module determines relevancy, the trafficking computer or the advertisement server may forward the advertisement data package at step 208. If the video-to-banner matching module determines that the video advertisement and the companion banner with which it is paired are not relevant to each other, the video-to-banner matching module may prevent submission of the advertisement data package to the advertisement server (in the embodiment in which the video-to-banner matching module is run on the trafficking computer) or the provision of the advertisement data package to the advertisement module (in the embodiment in which the video-to-banner matching module is run on the advertisement server). In an alternative example embodiment, the advertisement data package may be provided, but the trafficking computer and/or the advertisement server may output an error message, e.g., at the trafficking computer. The user may then be alerted to a potential error and correct any error in the data package that may be discovered during further user inspection.

In an example embodiment of the present invention, for generating the keywords, for example, where the method is implemented for drug advertisements, a speech tagger may used to recognize and parse a grammar of the video component and the banner component, tag the text with parts of speech, and analyze the tagged text to determine which word is likely the name of a drug. The system and method may then determine whether the companion banner includes the name of the drug.

In an alternative embodiment, other factors may be considered instead of or in addition to the inclusion in the banner of a probable drug name, as such a factor alone may be too strict, because the recognition of the drug name may be incorrect and/or the drug name may be intentionally left out of the companion banner. Any suitably appropriate method of generating keywords may be used and any suitably appropriate algorithm for determining relevance of media to each other based on keywords may be used. For example, any suitably appropriate keyword-based search algorithm which determines relevancy of content to keywords may be used.

For example, the system and method may compute a relevancy score based on a function whose input includes a plurality of factors. If the score meets a predefined threshold, then the companion banner and video component are considered relevant to each other and no error is logged. If the score does not meet the predefined threshold, then the companion banner and video component are considered to be unrelated to each other, an error may be logged, and/or the system and method may refrain from providing the data package in response to a content or advertisement request.

The relevancy check may be performed at the trafficking computer or advertisement server, rather than at the user terminal upon receipt of the advertisement data package, as performance of such a check at the user terminal, e.g., by the advertisement module, can cause a delay in playing of the advertisement content, since the check would be performed at runtime during the rendering of the webpage. Performance at the trafficking computer or advertisement computed, on the other hand, may be prior to runtime, e.g., prior to a request in response to which the data package is provided, and would therefore not affect response time at the user terminal.

In an alternative example embodiment, the relevancy check may be performed at the user terminal, e.g., by the advertisement module. Further, the relevancy check may be performed at runtime. In an example embodiment, the performance of the relevancy check at the user terminal may be such that it does not lengthen or noticeably lengthen response time. For example, the advertisement module may initially cause the output of the video advertisement and companion banner independent of the result of the relevancy check, so that they can be rendered without waiting for results of the relevancy check. In the background, e.g., during or subsequent to the rendering of the video advertisement and companion banner, the system and method may perform the relevancy check at the user terminal, e.g., via the advertisement module. While results of the relevancy check, at least initially, do not impact whether the advertisement data package is rendered, if the advertisement module determines, based on the relevancy check, that there is an error in the advertisement data package, the user terminal may send an error message to, e.g., the advertisement server or trafficking computer. A user may then be prompted to check to ensure that the data package does not include an error.

In an example embodiment of the present invention, the advertisement module may, alternatively or additionally, in response to a determination of a relevancy error, locally log the error. Subsequently, if the advertisement module receives the same advertisement data package again, the advertisement module may prevent rendition of the advertisement data package. For example, upon receipt of such an advertisement package, the system and method may invoke the failover mechanism or have the regular content continue without display of an advertisement, as described in detail above. Data packages may be assigned IDs, via which the system and method may determine whether the data package is one for which an error was previously logged.

In an example embodiment of the present, the prevention of the rendition may be limited by a time period and/or by a number of times the advertisement data package is received, for example, to account for a possibility of a fix to the advertisement data package.

In an example embodiment of the present invention, after an error is logged for an advertisement data package, the advertisement module may, upon subsequent receipt of the same advertisement data package, perform another relevancy check in addition to prevention of its rendition. The relevancy check may be re-performed for each such subsequent receipt of the same advertisement data package until the relevancy check is performed without resulting in an error, in which case, the system and method may remove the log entry noting the error. This embodiment may be combined with the previously described embodiment, so that the log entry is also automatically cleared after expiry of a predetermined time period (or even after a number of times the advertisement package is received). Additionally, in an example embodiment, the relevancy check may be omitted and/or such a log entry may be cleared where a parameter has been set indicating user-determined relevancy as described below.

In an example embodiment of the present invention, the system and method may be configured such that for any data package, a relevancy check is performed only once. For example, the system and method may output an error message, as described above, so that a user's attention may be drawn to the possible error. The system and method may be configured such that, thereafter, the advertisement data package is provided without logging of any error because it may be assumed that a user has confirmed relevancy.

In an example embodiment, the system and method may be configured for setting of a parameter to indicate that relevancy has already been checked, so that further relevancy checks are not performed for the data package. In an example embodiment, the setting of the parameter may be automatic or manual. For example, a user interface may be provided via which a user may set the parameter to indicate that relevancy has already been confirmed. In this way, multiple error messages for the same data package may be avoided and/or a decision to prevent provision of the data package in response to a request may be overridden.

FIG. 3 illustrates components of a system according to an example embodiment of the present invention. A user terminal 300 may be connected to a content server 325 and an advertisement server 350. The advertisement server 350 and/or the user terminal 300 may be connected to a trafficking computer 375. Connection may be via any network, e.g., the Internet. While these components are illustrated as separate components, a single component may include modules for taking on the role of any such component.

The user terminal 300 may include a processor 302 and a memory 304. The processor 302 may execute application modules stored in the memory 304. The memory 304 may include a buffer 305 and application modules, including, for example, a video player 306, an advertisement module 307, and a web browser application 308. Although not shown, the memory 304 may include other data, such as an error log as described above.

The content server 325 may include a processor 330 and a memory 335. The processor 330 may execute application modules stored in the memory 335, e.g., for responding to content requests. The memory 335 may also store content to be served in response to a content request. The content server 325 may also be connected to external storage devices from which to obtain content.

The advertisement server 350 may include a processor 355 and a memory 360. The processor 355 may execute application modules stored in the memory 360, e.g., for responding to advertisement requests. The application modules may include, for example, an advertisement filter module 362 for performing a relevancy check for a companion banner and associated video advertisement, as described above. In other example embodiments, the advertisement filter module 362 may be included at the trafficking computer 375 and/or at the user terminal 300, as described in detail above. The memory 360 may also store advertisement data packages as described above to be served in response to advertisement requests from the advertisement module 307. The advertisement server 350 may also be connected to external storage devices from which to obtain advertisement data packages.

The trafficking server 375 may include a processor 380 and a memory 385. The processor 380 may execute application modules stored in the memory 385, e.g., for providing a user interface via which to create advertisement data packages that may also be stored in the memory 385 and/or pushed to one or more advertisement servers.

As described in detail above, the content server 325 may transmit webpage data to the web browser application 308. Based on such data, the user terminal 300 may display a webpage 315 on a display device 303 of the user terminal 300. The webpage may include a video advertisement placeholder 317 and a companion banner placeholder 319. The advertisement module 307 may obtain an advertisement data package including a video advertisement, an associated companion banner, and handshake code, e.g., in an XML file, from the advertisement server 350. The web browser application 308 may render the companion banner in the companion banner placeholder 319 and the advertisement module 307 may render the video advertisement in the video advertisement placeholder 319.

While the examples described above refer to video advertisements and companion banners, the described methods for ensuring output of all associated components for output of any of the associated components are applicable to other content as well. Further, while the examples described above refer to video and a banner, the described methods for ensuring output of all associated components for output of any of the associated components are applicable to any two associated media components. Similarly, the described methods for checking relevancy of associated components are applicable to any two or more associated media that have a textual component for which keywords may be generated and/or any two or more associated media which include or otherwise are also associated with a component, such as metadata, from which keywords may be obtained.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The above description is intended to be illustrative, and not restrictive. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims. For example, the sequence of method steps illustrated in the flowcharts may be modified, so that certain steps occur in an order reverse of the illustrated order, and so that certain steps shown to be performed in sequence occur simultaneously. For example, steps 112 and 114 may be simultaneously performed. Further, steps 112 and 116 may be simultaneously performed, etc. Another example of a modification is that the video player 306 and advertisement module 307 may be implemented as a single module.

What is claimed is:

1. A computer-implemented media rendering method, comprising:
one or more computer processors performing the following:
obtaining a data package including a first media component, a second media component, and an instruction; and
in accordance with the instruction:
performing a procedure for rendering the second media component;
subsequently determining whether the second media component was rendered via the procedure; and
in accordance with the determination, rendering the first media component conditional upon the determination being that the second media component was rendered;
wherein the instruction provides that the first media component is not rendered in an instance where the determination is that the second media component was not rendered.

2. The method of claim 1, wherein the first media component is a video.

3. The method of claim 2, wherein the second media component is a companion banner.

4. The method of claim 3, wherein the first and second media components are an advertisement.

5. The method of claim 3, wherein the companion banner is a static media component.

6. The method of claim 1, wherein the first and second media components are rendered in a webpage.

7. The method of claim 6, further comprising:
executing a web browser module to:
transmit to a content server a request for the webpage;
receive from the content server webpage data; and
render components of the webpage based on the webpage data;
executing a media rendering module to:
request the data package from a first media server;
provide the second media component to the web browser module; and
buffer the first media component in a memory;
executing the web browser module to:
beginning while the first media component is buffering in the memory, perform the procedure for rendering the second media component obtained from the media rendering module; and
conditional upon the second media component being rendered in the webpage as a result of the procedure, provide a notification of the rendering of the second media component to the media rendering component; and
executing the media rendering module to:
perform the determining step, wherein the determination that the second media component was rendered is made responsive to receipt of the notification; and
perform the rendering of the first media component.

8. The method of claim 7, wherein, in response to the request for the data package, an intermediate package is received, the intermediate package including a primary link to a second media server and a failover link to the first media server.

9. The method of claim 1, wherein the instruction is a flag setting.

10. The method of claim 1, further comprising:
comparing at least one keyword associated the first media component and at least one keyword associated with the second media component;
in accordance with the comparison, determining whether the first and second media components are related;
wherein, if a determination is made in the determining step that the first and second media components are not related, at least one of (a) the data package is not transmitted, (b) the first and second media components are not rendered, and (c) a notification of the first and second media components not being related is transmitted.

11. A computer-implemented media rendering method, comprising:
one or more computer processors performing the following:
obtaining a data package including a first media component, a second media component, and an instruction; and
in accordance with the instruction:
performing a procedure for rendering the second media component;
subsequently determining whether the second media component was rendered via the procedure; and
either:
rendering the first media component if the determination is that the second media component was rendered; or
if the determination is that the second media component was not rendered, responsive to the determination, one of (a) requesting a new data package, (b) beginning or resuming a rendering of a third media component, the first media not being rendered, and (c) entering a waiting state without rendering of the first media component.

12. The method of claim 11, wherein the determination that the second media component was not rendered is made responsive to expiration of a predetermined time period without receipt of a notification of rendering of the second media component.

13. The method of claim 11, further comprising:
transmitting a request for the data package to a first media server;
responsive to the request for the data package, receiving from the first media server an intermediate package that includes a primary link to a second media server and a failover link to the first media server; and
communicating with the second media server via the primary link to receive the data package;
wherein:
if the determination is that the second media component was not rendered, responsive to the determination, the new data package is requested; and
the request for the new data package is made via the failover link.

14. A computer-implemented media rendering method, comprising:
one or more computer processors performing the following:
executing a web browser module to:
request a webpage from a first server;
receive from the first server webpage data, transmitted by the first server in response to the request for the webpage;
render components of the webpage using the received webpage data; and
in accordance with the webpage data, invoke a media rendering module;
responsive to the invocation, executing the media rendering module to:
obtain a data package including a first media component, a second media component, and a linking instruction;
provide to the web browser module the second media component and, in response to the linking instruction, a notification instruction; and
buffer data of the first media component;
executing the web browser module to:
responsive to the provision of the second media component and beginning while the data of the first media component is being buffered in the memory, perform a procedure for rendering the second media component; and
in accordance with the notification instruction, if the second media component is rendered in the webpage as a result of the procedure, provide a notification of the rendering of the second media component to the media rendering component; and
executing the media rendering module to determine whether the notification has been received from the web browser module within a predetermined time period, the first media component being rendered in the webpage from the memory conditional upon a determination that the notification has been received.

15. A system for rendering media, comprising:
a computer processors configured to:
obtain a data package including a first media component, a second media component, and an instruction; and
in accordance with the instruction:
perform a procedure for rendering the second media component;
subsequently determine whether the second media component was rendered via the procedure; and
in accordance with the determination, render the first media component conditional upon the determination being that the second media component was rendered, the first media component not being rendered where the determination is that the second media component was not rendered.

16. A computer-readable medium having stored thereon instructions executable by a computer processor, the instructions which, when executed, cause the computer processor to perform a media rendering method, the media rendering method comprising:
obtaining a data package including a first media component, a second media component, and an instruction; and
in accordance with the instruction:
performing a procedure for rendering the second media component;
subsequently determining whether the second media component was rendered via the procedure; and
in accordance with the determination, rendering the first media component conditional upon the determination being that the second media component was rendered, the first media component not being rendered where the determination is that the second media component was not rendered.

17. A computer-implemented method for providing media content, comprising:
in response to a request for media content, transmitting, by a computer processor, a data package including a first media component, a second media component, and an instruction including code that causes a receiver of the data package to, in accordance with a determination of whether the second media component has been rendered, determine whether to render the first media component;
wherein the instruction makes rendering of the first media component conditional on the rendering of the second media component.
